(19) United States
(12) Patent Application Publication
(10) Pub. No.: US 2013/0145905 A1
(43) Pub. Date: Jun. 13, 2013

(54) Pole Assembly

(71) Applicant: Chris Calvert, Gilbert, AZ (US)

(72) Inventor: Chris Calvert, Gilbert, AZ (US)

(21) Appl. No.: 13/670,437

(22) Filed: Nov. 6, 2012

Related U.S. Application Data
(60) Provisional application No. 61/568,585, filed on Dec. 8, 2011.

(51) Int. Cl. B25B 23/00

(52) U.S. Cl. CPC B25B 23/0035
USPC 81/53.1

(57) ABSTRACT

A pole assembly includes a chuck, and the chuck includes a chuck body with opposed fastener openings extending therethrough, and a shank. The pole assembly includes a socket piece, and the socket piece includes a conduit fitting body and a socket piece body, and opposed fastener openings extending through the conduit fitting body, and a socketed body opening extending through the socket fitting body. The pole assembly includes a conduit which extends through a distal chuck body opening of the chuck and an unsocketed body opening of the conduit fitting body.

### CROSS-REFERENCE TO RELATED APPLICATIONS

This application claims the benefit of U.S. Provisional Application No. 61/568,585, entitled “A CUSTOMIZABLE EXTENSION SOCKET INSTALLATION TOOL FOR VERTICAL MOUNT WOOD AND STEEL FASTENERS SUCH AS SAMMY'S”, which was filed on Dec. 8, 2011, the contents of which are incorporated by reference as though fully set forth herein.

### BACKGROUND OF THE INVENTION

1. Field of the Invention

This invention relates generally to hand and hoist-line implements.

2. Description of the Related Art

It is often necessary for a person, such as an electrician, to hoist an object to a height that the electrician cannot reach. For example, an electrician's pole can be used to hoist a screw to a ceiling, wherein the screw is threaded into the ceiling using the pole. One type of electrician's pole is often referred to as a Lagmaster Pole, and it can be used to hoist many different types of objects, such as a wire, threaded and smooth rods, a jack chain and a J-hook. One problem with the available electrician's poles is that they are expensive and limited in size and strength.

### BRIEF SUMMARY OF THE INVENTION

The present invention is directed to a pole assembly for hoisting an object. The novel features of the invention are set forth with particularity in the appended claims. The invention will be best understood from the following description when read in conjunction with the accompanying drawings.

### BRIEF DESCRIPTION OF THE DRAWINGS

It should be noted that like reference characters are used throughout the various views of the Drawings.

FIG. 1 is a perspective view of various embodiments of a pole assembly.

FIGS. 2a and 2b are perspective views of wood and concrete fasteners, respectively.

FIG. 3 is a perspective view of a conduit.

FIG. 4a is a perspective view of a template used to form a fastener opening at a desired location.

FIG. 4b is a cut-away perspective view of the template of FIG. 4a taken along a cut-line 4b-4b of FIG. 4a.

FIG. 4c is a cut-away perspective view of the template of FIG. 4a taken along a cut-line 4c-4c of FIG. 4a.

FIGS. 5a, 5b and 5c are perspective views of a fastener opening being formed through a proximal end of the conduit of FIG. 2 using the template of FIGS. 4a-4c.

FIGS. 6a, 6b and 6c are perspective views of a fastener opening being formed through a distal end of the conduit of FIG. 2 using the template of FIGS. 4a-4c.

FIG. 7a is a perspective view of a chuck used to couple the conduit of FIGS. 5a-5c and FIGS. 6a-6c to a drill, as shown in FIG. 1.

FIG. 7b is a cut-away perspective view of the chuck of FIG. 7a taken along a cut-line 7b-7b of FIG. 7a.

FIG. 7c is a cut-away perspective view of the chuck of FIG. 7a taken along a cut-line 7c-7c of FIG. 7a.

FIG. 8a is a perspective view of a socket piece used to couple a fastener to the conduit of FIGS. 5a-5c and FIGS. 6a-6c, as shown in FIG. 1.

FIG. 8b is a cut-away perspective view of the socket piece of FIG. 8a taken along a cut-line 8b-8b of FIG. 8a.

FIG. 8c is a cut-away perspective view of the socket piece of FIG. 8a taken along a cut-line 8c-8c of FIG. 8a.

FIG. 8d is a top view of the socket piece of FIG. 8a showing a socketed body opening.

FIG. 9 is a perspective view of one embodiment of the pole assembly of FIG. 1.

FIG. 10a is a perspective view of a coupler included with another embodiment of a pole assembly of FIG. 1.

FIG. 10b is a cut-away perspective view of the coupler of FIG. 10a taken along a cut-line 10b-10b of FIG. 10a.

FIG. 10c is a cut-away perspective view of the coupler of FIG. 10a taken along a cut-line 10c-10c of FIG. 10a.

FIG. 10d is a cut-away perspective view of the coupler of FIG. 10a taken along a cut-line 10d-10d of FIG. 10a.

FIG. 11a is a perspective view of the proximal end of the embodiment of the pole assembly of FIG. 1 which includes the coupler of FIG. 10a.

FIG. 11b is a perspective view of a center portion of the embodiment of the pole assembly of FIG. 1 which includes the coupler of FIG. 10a.

FIG. 11c is a perspective view of a distal end of the embodiment of the pole assembly of FIG. 1 which includes the coupler of FIG. 10a.

FIG. 12a is a perspective view of a universal socket which can be coupled to a conduit.

FIG. 12b is a cut-away perspective view of the universal socket of FIG. 12a taken along a cut-line 12b-12b of FIG. 12a.

FIG. 12c is a cut-away perspective view of the universal socket of FIG. 12a taken along a cut-line 12c-12c of FIG. 12a.

FIG. 12d is a cut-away perspective view of the universal socket of FIG. 12a taken along a cut-line 12d-12d of FIG. 12a.

FIG. 13a is a perspective view of a socketed chuck which can be coupled to the universal socket of FIG. 12a.

FIG. 13b is a perspective view of a socketed plug which can be coupled to the socketed chuck of FIG. 13a.

FIG. 13c is a perspective view of the fastener of FIG. 3a which can be coupled to the socketed plug of FIG. 13b.

### DETAILED DESCRIPTION OF THE INVENTION

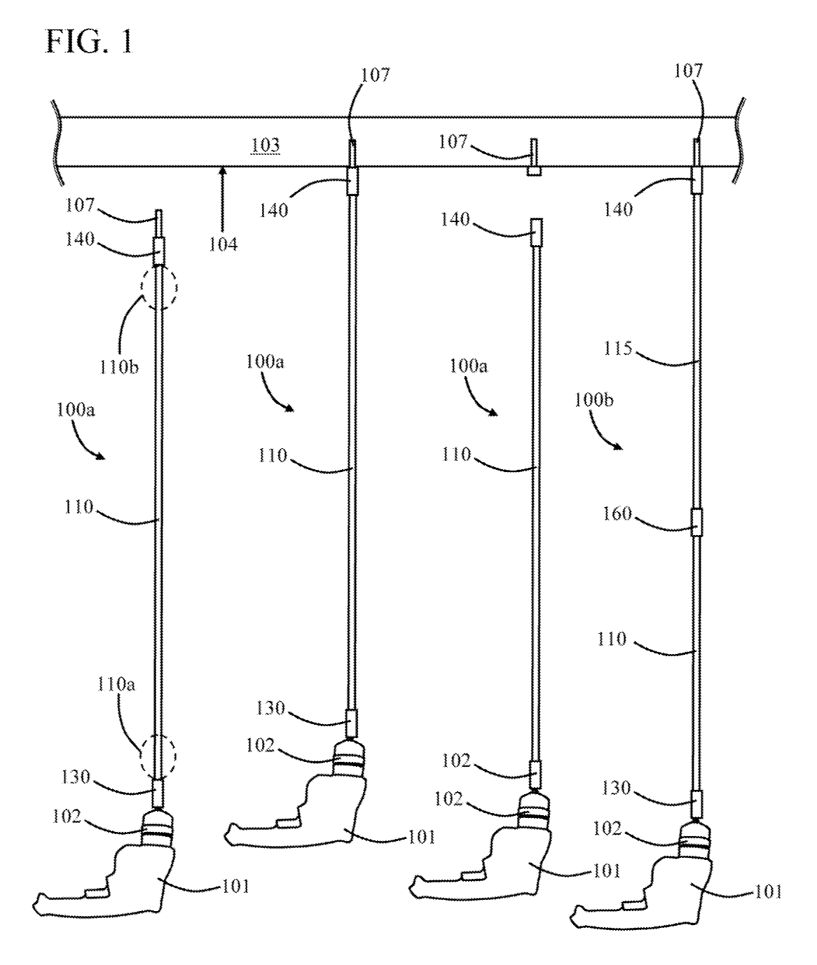

FIG. 1 is a perspective view of various embodiments of a pole assembly, denoted as pole assemblies 100a and 100b. In these embodiments, pole assemblies 100a and 100b are operatively coupled to a drill 101 through a drill chuck 102. Pole assemblies 100a and 100b rotate in response to the rotation of drill chuck 102. Pole assemblies 100a and 100b are used to hoist a fastener 107 so it can be extending through a surface 104 and fastened to a ceiling 103.

In this embodiment, pole assembly 100a includes a conduit 110, and a chuck 130 and socket piece 140 coupled to opposed proximal and distal ends 110a and 110b of conduit 110. Proximal end 110a is coupled to drill chuck 102, and distal end 110b is positioned away from drill chuck 102.

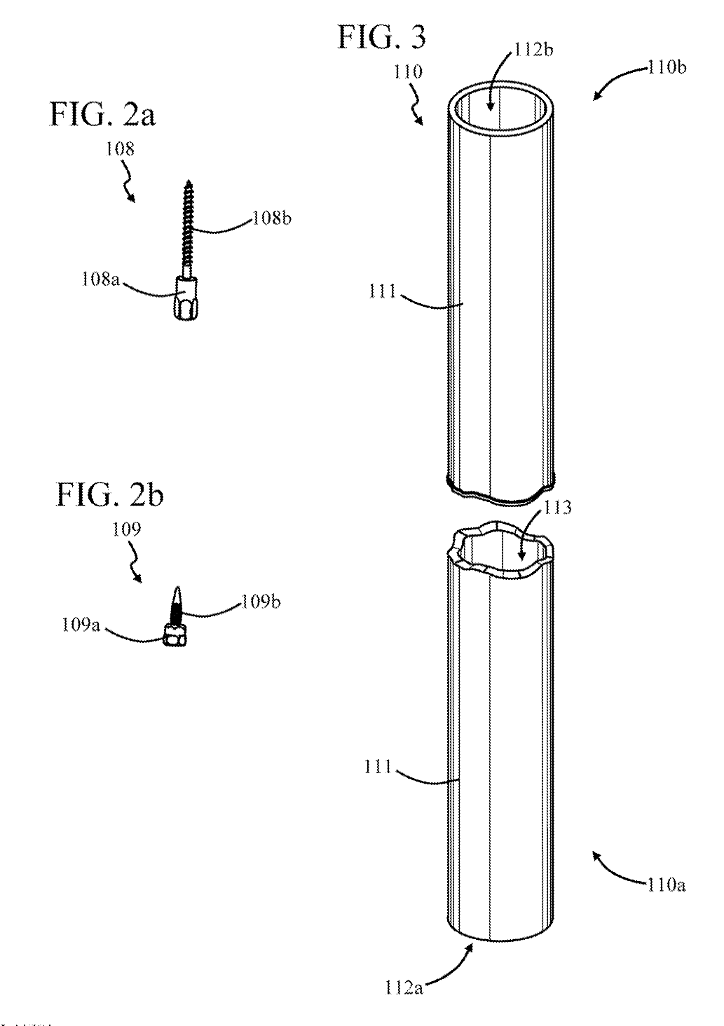

Fastener 107 can be of many different types of fasteners. FIGS. 2a and 2b are perspective views of wood and concrete fasteners 108 and 109, respectively. Wood fastener 108 includes a head 108a and a threaded shaft 108b extending therefrom. Wood fastener 108 is designed to be fastened to wood, such as when ceiling 103 includes wood and surface 104 corresponds to a wood surface. Concrete fastener 109 is designed to be fastened to concrete, such as when ceiling 103 includes concrete and surface 104 corresponds to a concrete surface. It should be noted that fastener 107 can be many other different types of objects, such as a wire, threaded and smooth rods, a jack chain and a J-hook.

FIG. 3 is a perspective view of conduit 110. Conduit 110 can be of many different types, such as electrical conduit used to protect and route electrical wiring. In this embodiment, conduit 110 includes a conduit body 111 with a conduit body channel 113 extending therethrough. Conduit body channel 113 extends between a proximal conduit body opening 112a and distal conduit body opening 112b. Proximal conduit body opening 112a and distal conduit body opening 112b are positioned at proximal end 110a and distal end 110b, respectively, of conduit 110. Conduit 110 can be coupled to chuck 130 and socket piece 140 in many different ways, one of which will be discussed in more detail presently.

It should be noted that pole assembly 100b of FIG. 1 includes a conduit 115, which can be the same or similar to conduit 110. In some embodiments conduits 110 and 115 have the same lengths and, in other embodiments, conduits 110 and 115 have different lengths. Conduit 115 includes a conduit body 116 with a conduit body channel extending therethrough. The conduit body channel extends between a proximate conduit end 115a and distal conduit end 115b.

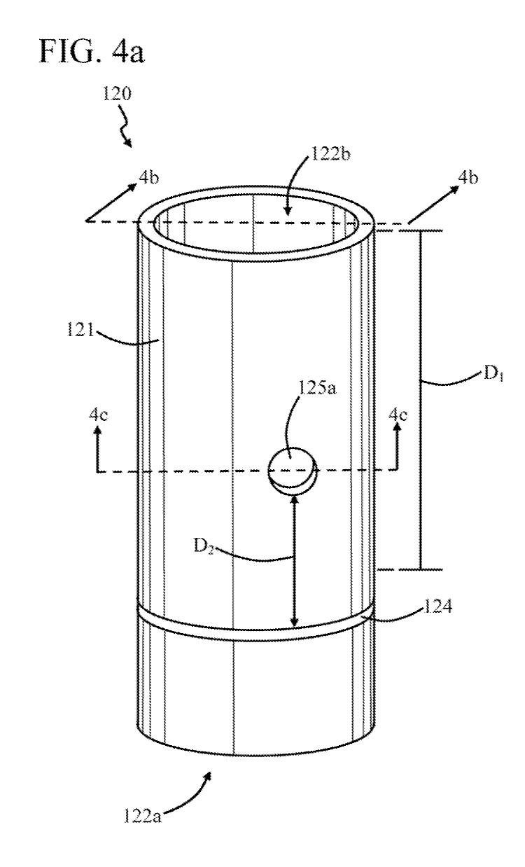

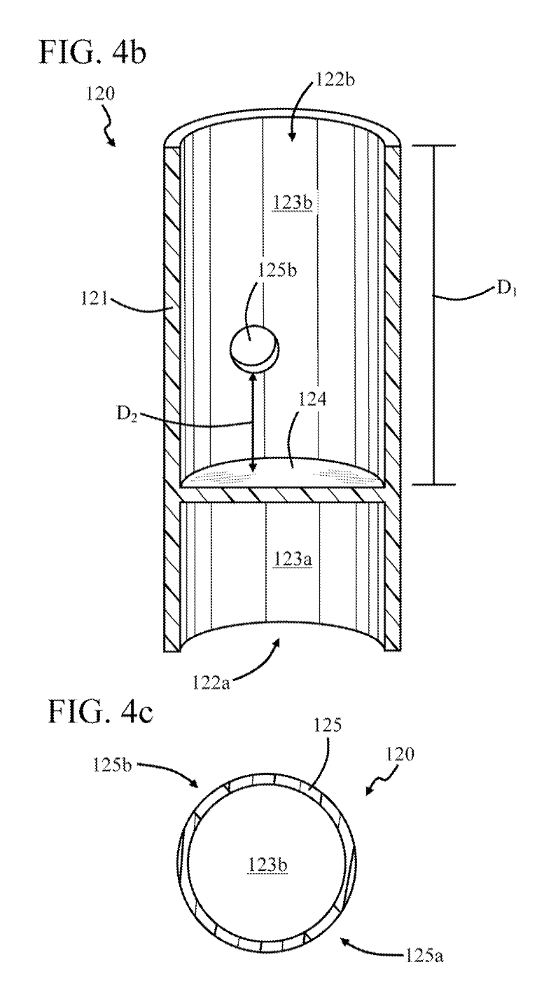

FIG. 4a is a perspective view of a template 120 used to form a fastener opening at a desired location, such as with conduit 110. FIG. 4b is a cut-away perspective view of template 120 taken along a cut-line 4b-4b of FIG. 4a, and FIG. 4c is a cut-away perspective view of template 120 taken along a cut-line 4c-4c of FIG. 4a.

In this embodiment, template 120 includes a template body 121, and proximal template body opening 122a and distal template body opening 122b at opposed ends. A template body channel 123a extends through template body 121 and between template body opening 122a and a template stop piece 124. A template body channel 123b extends through template body 121 and between template body opening 122b and template stop piece 124. A distance between template body opening 122b and template stop piece 124 is denoted as distance D₁ in FIGS. 4a and 4b.

Template 120 includes opposed fastener openings 125a and 125b, which extend through template body 121. Fastener openings 125a and 125b are positioned opposed to each other, as shown in FIG. 4c, so that an object, such as a fastener, can be extended through them. A distance between stop piece 124 and a bottom portion of fastener opening 125a is denoted as distance D₂ in FIG. 4a. Further, a distance between stop piece 124 and a bottom portion of fastener opening 125b is denoted as distance D₂ in FIG. 4b. In this way, the bottom portions of fastener openings 125a and 125b are positioned the same distance from stop piece 124.

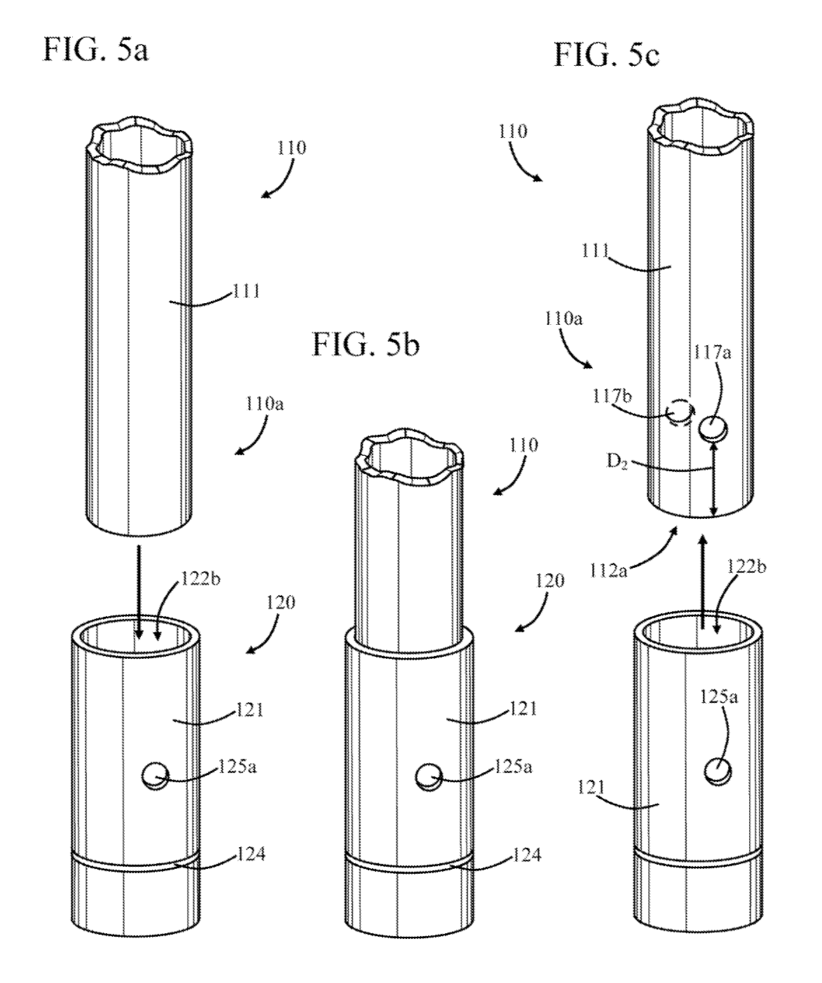

FIGS. 5a, 5b and 5c are perspective views of conduit fastener openings 117a and 117b (FIG. 5c) being formed through proximal end 110a of the conduit 110 of FIG. 2 using template 120 of FIGS. 4a-4c. Conduit fastener openings 117a and 117b are used to couple proximal end 110a of conduit 110 to another piece, such as chuck 130. In operation, proximal end 110a is moved through template body opening 122b and template body channel 123b so it engages template stop piece 124. As mentioned above, the distance between template body opening 122b and template stop piece 124 is distance D₁. Hence, a length of conduit 110 which extends through template body channel 123b corresponds to distance D₁. A drill bit (not shown) is extended through fastener openings 125a and 125b and proximal end 110a of conduit 110 to form conduit fastener openings 117a and 117b (FIG. 5c), wherein a bottom portion of conduit fastener openings 117a and 117b are positioned distance D₁ from proximal conduit body opening 112a. In this way, conduit fastener openings 117a and 117b are formed at a desired location with conduit 110. It should be noted that template 120 typically includes a hardened metal material, such as tool steel, so that fastener openings 125a and 125b resist being worn out in response to extending the drill bit therethrough.

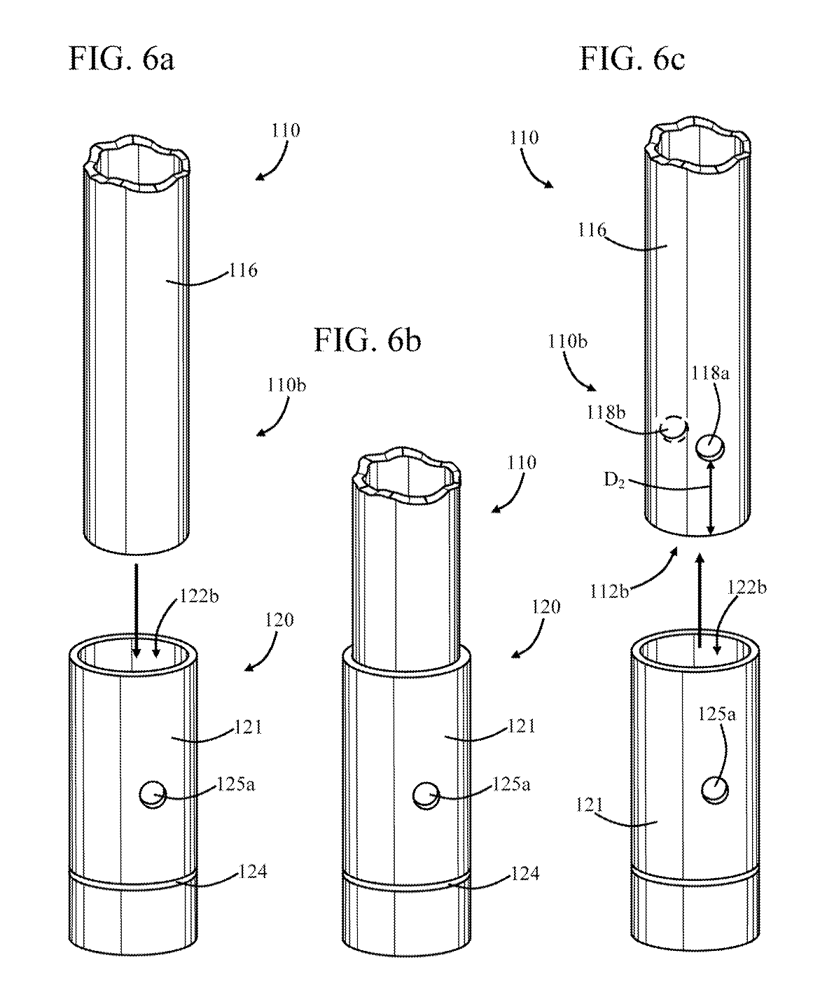

FIGS. 6a, 6b and 6c are perspective views of conduit fastener openings 118a and 118b (FIG. 6c) being, formed through distal end 110b of the conduit 110 of FIG. 2 using template 120 of FIGS. 4a-4c. Conduit fastener openings 118a and 118b are used to couple distal end 110b of conduit 110 to another piece, such as socket piece 140. In operation, distal end 110b is moved through template body opening 122b and template body channel 123b so it engages template stop piece 124. As mentioned above, the distance between template body opening 122b and template stop piece 124 is distance D₁. Hence, a length of conduit 110 which extends through template body channel 123b corresponds to distance D₁. A drill bit (not shown) is extended through fastener openings 125a and 125b and distal end 110b of conduit 110 to form conduit fastener openings 118a and 118b (FIG. 6c), wherein a bottom portion of conduit fastener openings 118a and 118b are positioned distance D₁ from distal conduit body opening 112b. In this way, conduit fastener openings 118a and 118b are formed at a desired location with conduit 110.

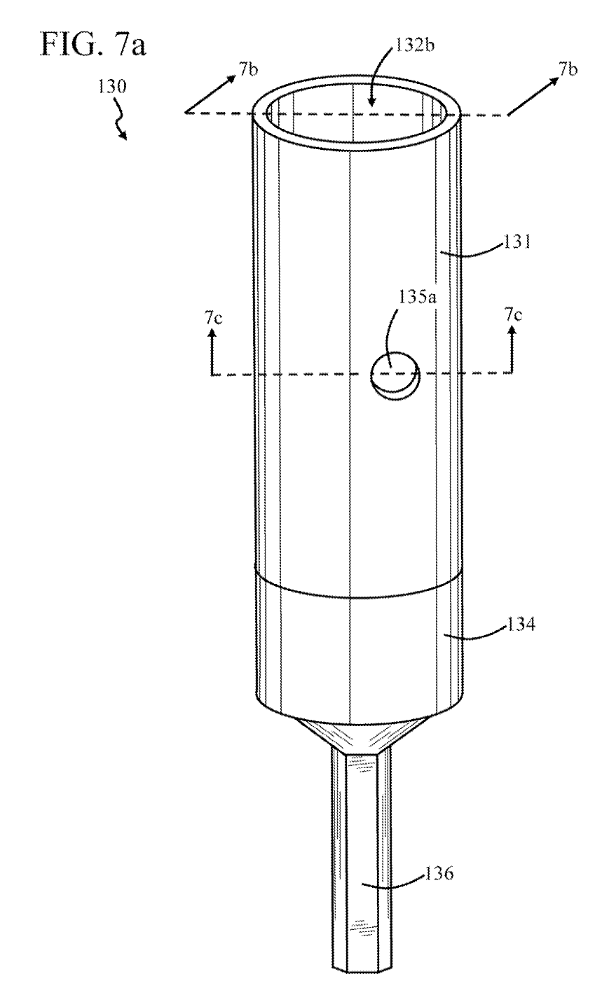

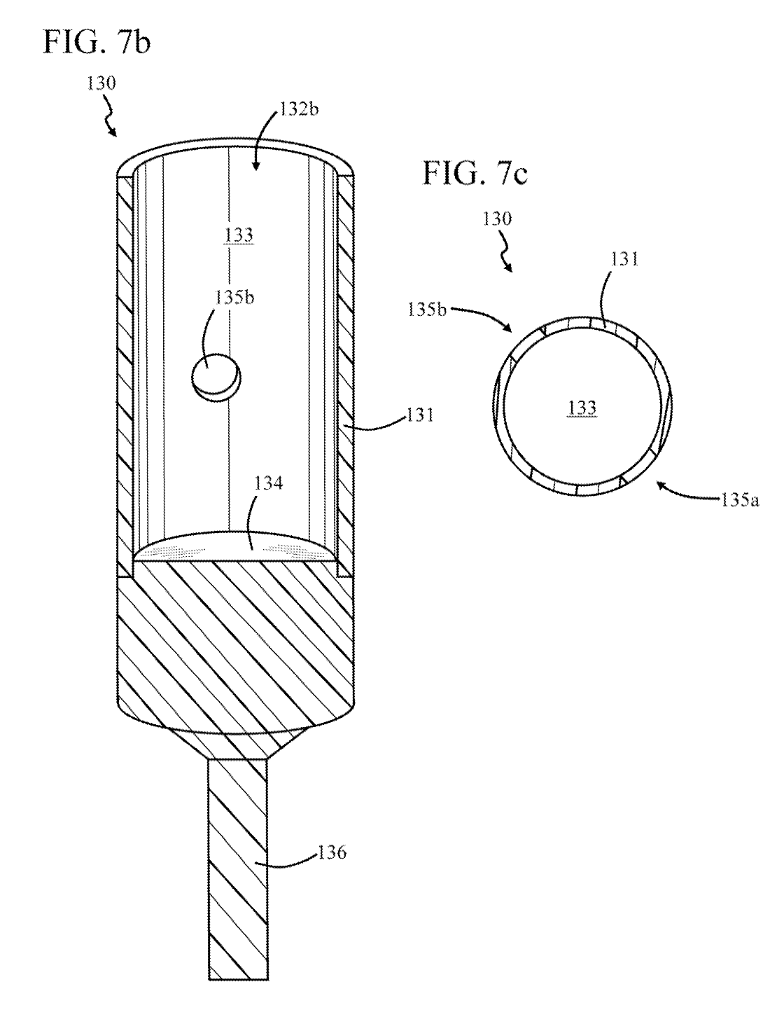

FIG. 7a is a perspective view of one embodiment of chuck 130, which is used to couple conduit 120 of FIGS. 5a-5c and FIGS. 6a-6c to drill 101, as shown in FIG. 1. FIG. 7b is a cut-away perspective view of chuck 130 taken along a cut-line 7b-7b of FIG. 7a, and FIG. 7c is a cut-away perspective view of chuck 130 taken along a cut-line 7c-7c of FIG. 7a.

In this embodiment, chuck 130 includes a chuck body 131, and a distal chuck body opening 132b at one end. Distal chuck body opening 132b is sized and shaped to receive proximate conduit end 110a of conduit 110. A chuck body channel 133 extends through chuck body 131 and between distal chuck body opening 132b and a chuck stop piece 134. Chuck 130 includes a shank 136 which extends away from distal chuck body opening, 132b and chuck stop piece 134. Shank 136 is extended through the drill chuck 102 of drill 101, as shown in FIG. 1.

Chuck 130 includes opposed fastener openings 135a and 135b, which extend through chuck body 131. Fastener openings 135a and 135b are positioned opposed to each other, as shown in FIG. 7c, so that an object, such as a fastener, can be extended through them. Further, fastener openings 135a and 135b are positioned so that conduit fastener openings 117a and 117b are aligned with fastener openings 135a and 135b, respectively, when proximate conduit end 110a of conduit 110 is extended through distal chuck body opening 132b. In this way, a fastener (not shown) can be extended through fastener openings 135a and 135b and conduit fastener openings 117a and 117b so that chuck 130 and proximate conduit end 110a of conduit 110 are coupled together, as shown in FIG. 1.

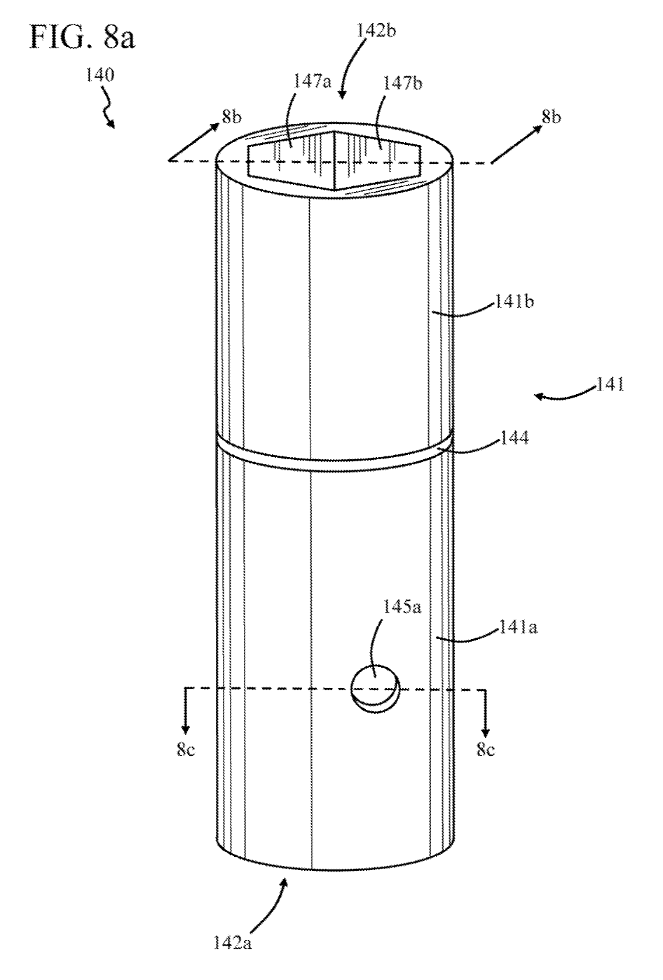

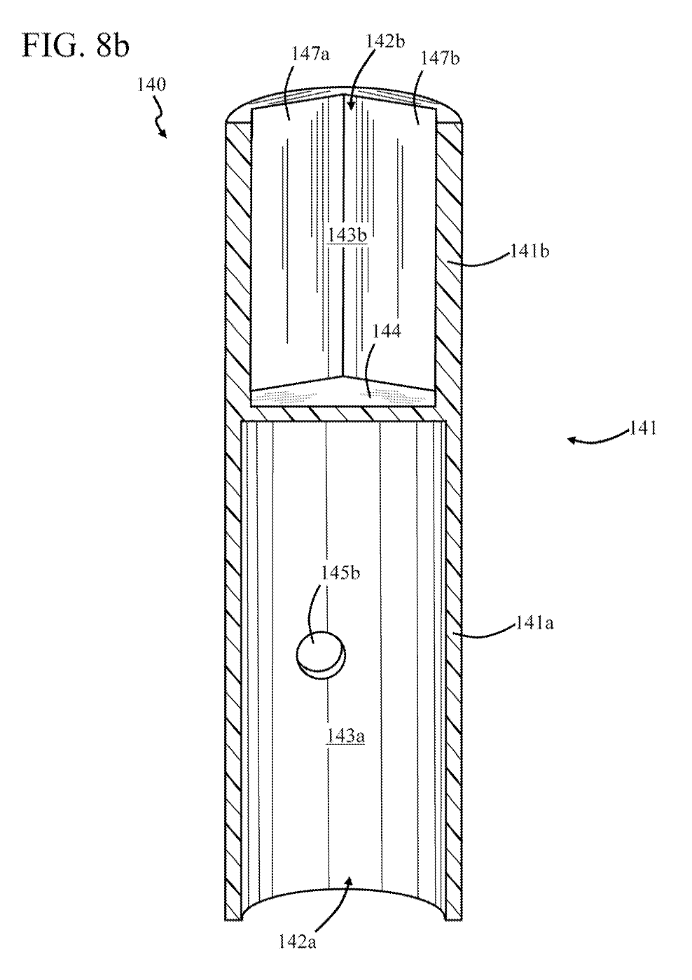

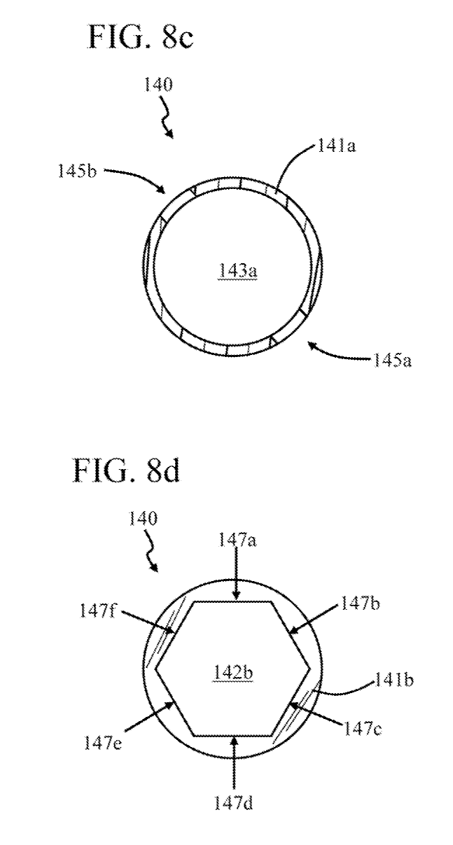

FIG. 8a is a perspective view of one embodiment of socket piece 140, which is used to couple fastener 107 to conduit 110 of FIGS. 5a-5c and FIGS. 6a-6c, as shown in FIG. 1. FIG. 8b is a cut-away perspective view of socket piece 140 of FIG. 8a taken along a cut-line 8b-8b of FIG. 8a, and FIG. 8c is a cut-away perspective view of socket piece 140 of FIG. 8a taken along a cut-line 8c-8c of FIG. 8a. FIG. 8d is a top view of a socket piece of FIG. 8a showing a socketed body opening 142b.

In this embodiment, socket piece 140 includes a socket piece body 141 having a conduit fitting body 141a and socket fitting body 141b. An unsocketed body opening 142a extends through conduit fitting body 141a, and an unsocketed body channel 143a extends through conduit fitting body 141a and between unsocketed body opening 142a and a socket stop piece 144. Unsocketed body opening 142a is sized and shaped to receive distal conduit end 110b of conduit 110. Body channel 143a is unsocketed because it does not include a facet.

A socketed body opening 142b extends through socket fitting body 141b, and a socketed body channel 143b extends through socket fitting body 141b and between socketed body opening 142b and socket stop piece 144. Channel body 143b is socketed because it includes a facet, which are denoted as facets 147a, 147b, 147c, 147d. 147e and 147f in FIG. 8d. It should be noted that six facets are shown in FIG. 8d for illustrative purposes. In general, channel body 143b is socketed because it includes one or more facets. Socketed body opening 142b is sized and shaped to receive a fastener, such as fastener 107 of FIG. 1, or fasteners 108 and 109 of FIGS. 2a and 2b, respectively. It should be noted that the number of facets of channel body 143b is chosen to match the number of facets of head 108a or head 109a. in this way, heads 108a and 109a are capable of extending through socketed body opening 142b and socketed body channel 143b. Channel body 143b is faceted so that the fastener received by socketed body opening 142b rotates in response to the rotation of socket piece 140.

Socket piece 140 includes opposed fastener openings 145a and 145b, which extend through socket piece body 141. Fastener openings 145a and 145b are positioned opposed to each other, as shown in FIG. 8c, so that an object, such as a fastener, can be extended through them. Further, fastener openings 145a and 145b are positioned so that conduit fastener openings 118a and 118b are aligned with fastener openings 145a and 145b, respectively, when distal conduit end 110b of conduit 110 is extended through unsocketed body opening 142a. In this way, a fastener (not shown) can be extended through unsocketed body opening 142a and conduit fastener openings 118a and 118b so that socket piece 140 and distal conduit end 110b of conduit 110 are coupled together, as shown in FIG. 1

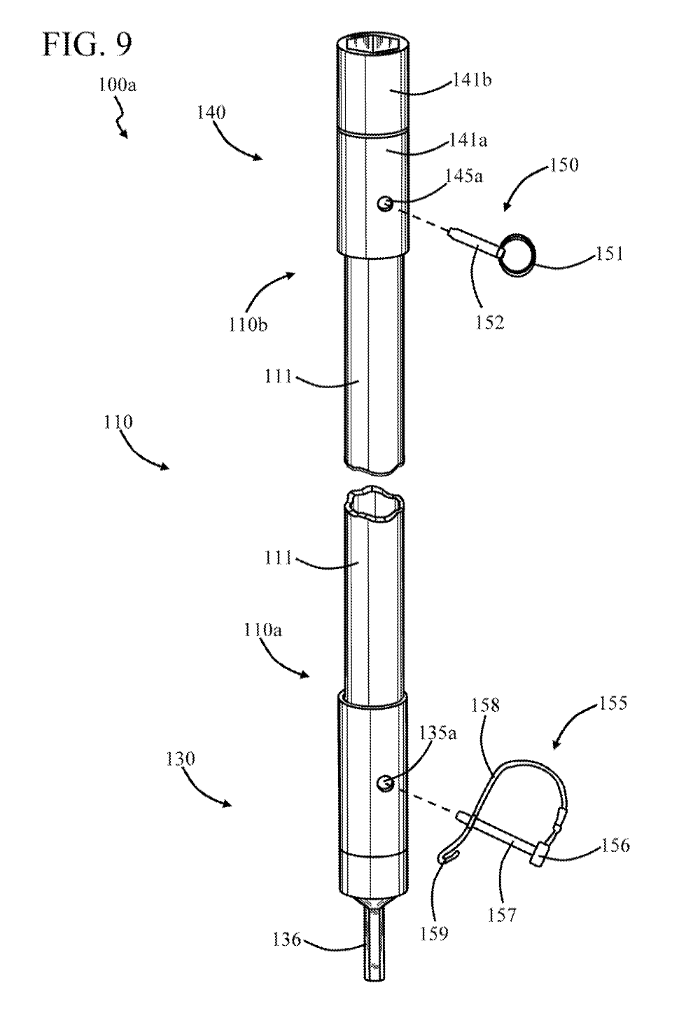

FIG. 9 is a perspective view of one embodiment of pole assembly 100a of FIG. 1. In this embodiment, chuck 130 is coupled to proximal end 110a of conduit 110 by using a locking pin 155. It should be noted, however, that chuck 130 and proximal end 110a of conduit 110 can be coupled together in many different ways, such as by using various pins and fasteners. In this embodiment, locking pin 155 includes a pin head 156 with a pin shank 157 extending therefrom. Pin shank 157 extends through fastener openings 135a and 135b, as well as through conduit fastener openings 117a and 117b. Locking pin 155 includes a loop 158 coupled to pin head 156, and loop 158 includes a locking loop 159 at a distal end thereof. Locking loop 159 can be locked to the distal end of pin shank 157 to hold locking pin 144 in place. In this way, chuck 130 and the proximal end 110a of conduit 110 are coupled together with a locking pin.

In this embodiment, socket piece 140 is coupled to distal end 110b of conduit 110 by using a pin 150. It should be noted, however, that socket piece 140 and distal end 110b of conduit 110 can be coupled together in many different ways, such as by using various pins and fasteners. In this embodiment, pin 150 includes a pin ring 151 with a pin shank 152 extending therefrom. Pin shank 152 extends through fastener openings 145a and 145b, as well as through conduit fastener openings 118a and 118b. In this way, socket piece 140 and the distal end 110b of conduit 110 are coupled together with a pin.

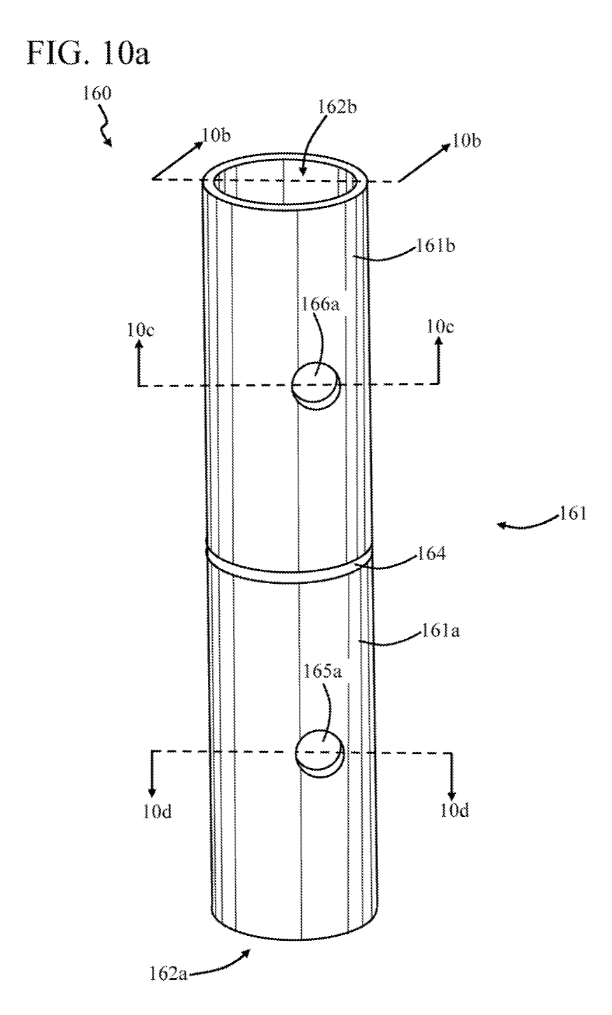

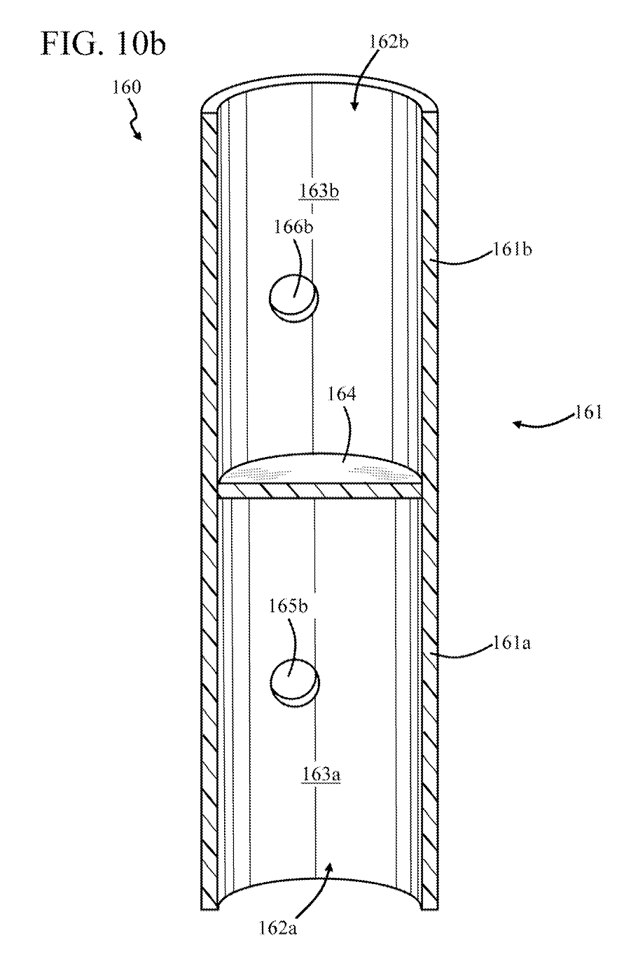

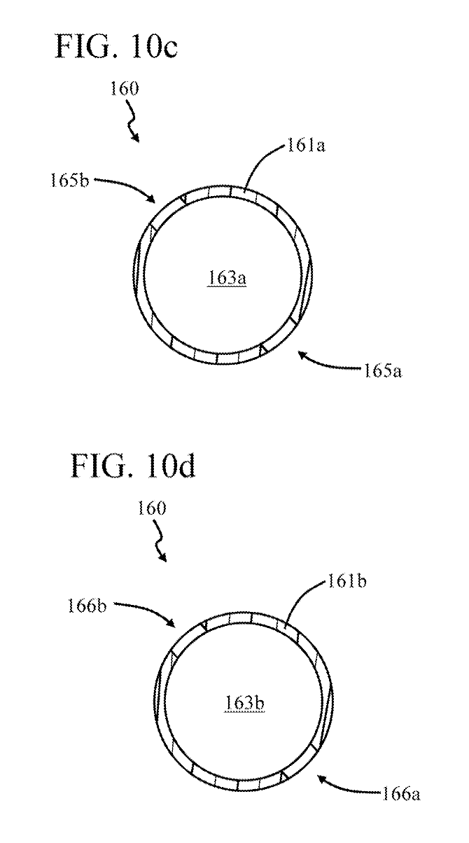

FIG. 10a is a perspective view of a coupler 160 included with pole assembly 100b of FIG. 1. FIG. 10b is a cut-away perspective view of coupler 160 taken along a cut-line 10b-10 b of FIG. 10a, and FIG. 10c is a cut away perspective view of coupler 160 taken along a cut-line 10c-10c of FIG. 10a. FIG. 10d is a cut-away perspective view of coupler 160 taken along a cut-line 10d-10d of FIG. 10a.

In this embodiment, coupler 160 includes a coupler body 161 having a proximal conduit fitting body 161a and distal conduit fitting body 161b. Coupler 160 includes a proximal coupler opening 162a which extends through proximal conduit fitting body 161a and a distal coupler opening 162b which extends through distal conduit fitting body 161b. A proximal conduit body channel 163a extends through proximal conduit fitting body 161a and between proximal coupler opening 162a and a coupler stop piece 164. A distal conduit body channel 163b extends through distal conduit fitting body 161b and between distal coupler opening 162b and coupler stop piece 164.

Coupler 160 includes opposed proximal fastener openings 165a and 165b, which extend through proximal conduit fitting body 161a. Proximal fastener openings 165a and 165b are positioned opposed to each other, as shown in FIG. 10c, so that an object, such as a fastener, can be extended through them.

Coupler 160 includes opposed distal fastener openings 166a and 166b, which extend through distal conduit fitting body 161b. Distal fastener openings 166a and 166b are positioned opposed to each other, as shown in FIG. 10d, so that an object, such as a fastener, can be extended through them.

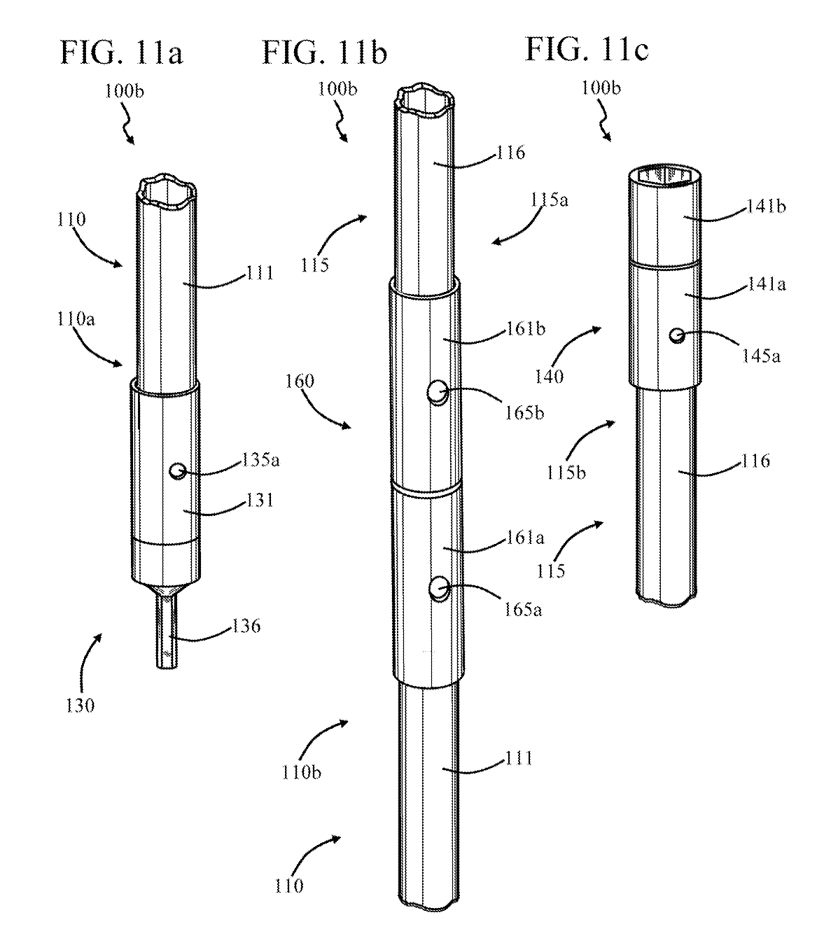

FIG. 11a is a perspective view of the proximal end of pole assembly 100b of FIG. 1, which includes coupler 160 of FIG. 10a. FIG. 11b is a perspective view of a center portion of pole assembly 100b of FIG. 1, which includes coupler 160 of FIG. 10a, and FIG. 11c is a perspective view of a distal end of pole assembly 100b of FIG. 1, which includes coupler 160 of FIG. 10a.

In this embodiment, pole assembly 100b includes chuck 130, which is discussed in more detail above. Chuck 130 is coupled to proximal end 110a of conduit 110 by using a locking pin (not shown), such as locking pin 150 or 155. It should be noted, however, that chuck 130 and proximal end 110a of conduit 110 can be coupled together in many different ways, such as by using various pins and fasteners.

In this embodiment, pole assembly 100b includes coupler 160, which is discussed in more detail above. Coupler 160 is coupled to a distal end 110b of conduit 110 by using a locking pin (not shown), such as locking pin 150 or 155. It should be noted, however, that coupler 160 and distal end 110b of conduit 110 can be coupled together in many different ways, such as by using various pins and fasteners. Coupler 160 is coupled to proximal end 115b of conduit 115 by using a locking pin (not shown), such as locking pin 150 or 155. It should be noted, however, that coupler 160 and distal end 115b of conduit 115 can be coupled together in many different ways, such as by using various pins and fasteners.

In this embodiment, pole assembly 100b includes socket piece 140, which is discussed in more detail above. Socket piece 140 is coupled to distal end 115b of conduit 115 by using a locking pin (not shown), such as locking pin 150 or 155. It should be noted, however, that socket piece 140 and distal end 115b of conduit 115 can be coupled together in many different ways, such as by using various pins and fasteners.

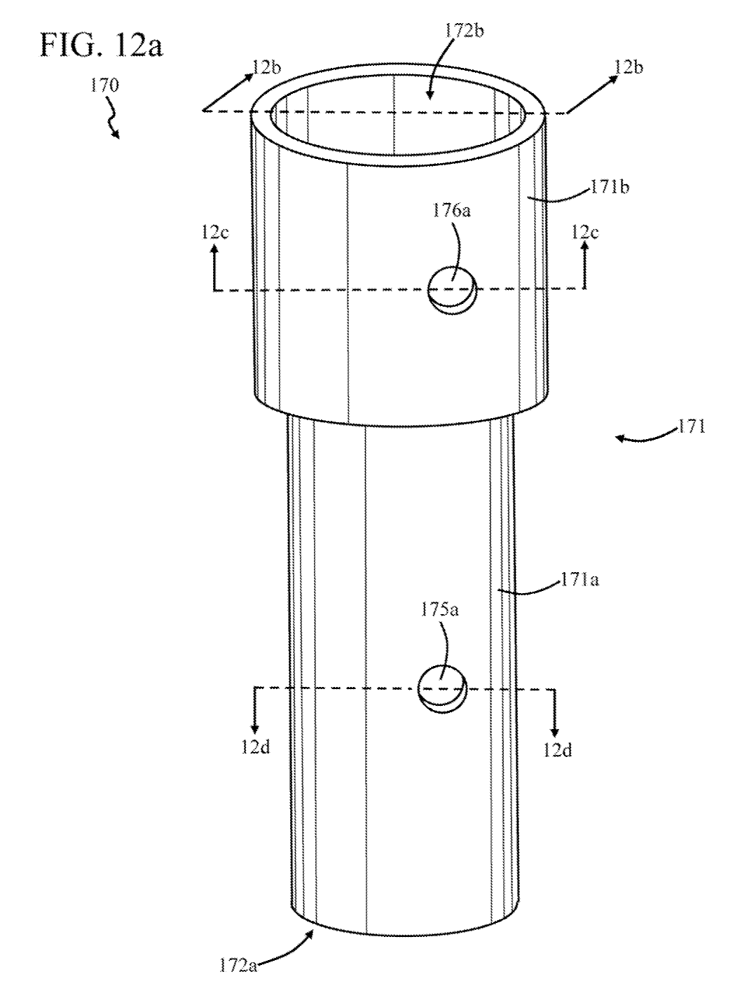

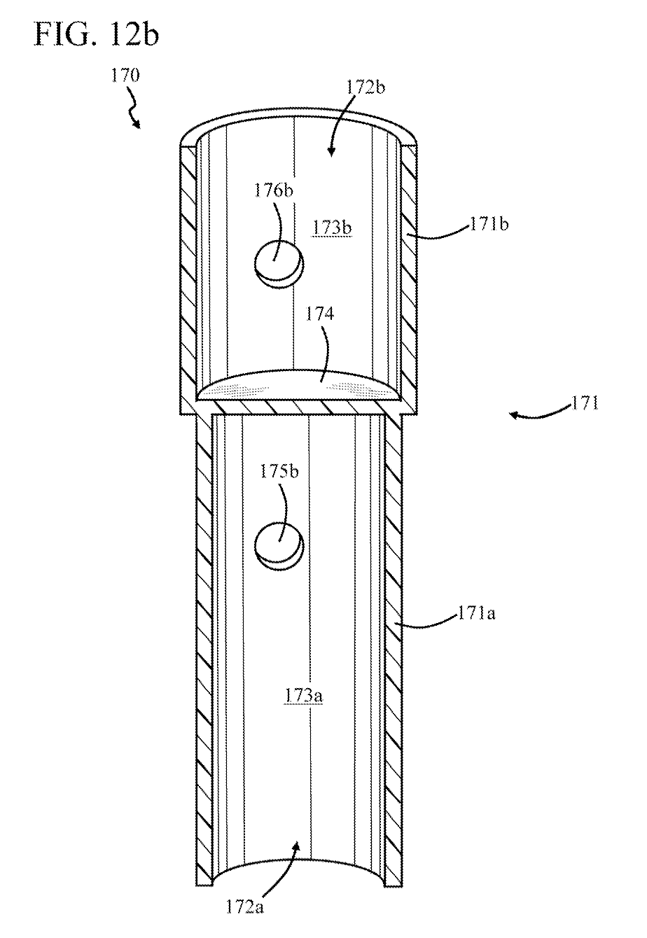

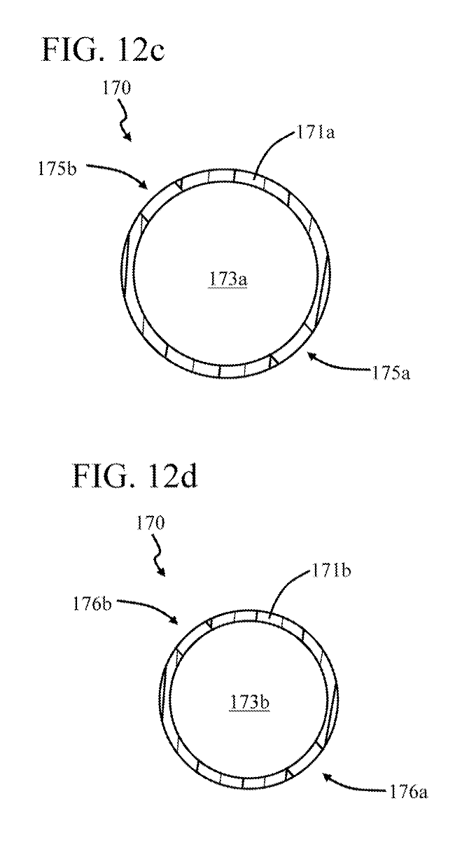

FIG. 12a is a perspective view of a universal socket 170 which can be coupled to a conduit, such as conduit 110. FIG. 12b is a cut-away perspective view of universal socket 170 taken along a cut-line 12b-12b of FIG. 12a, and FIG. 12c is a cut-away perspective view of universal socket 170 taken along a cut-line 12c-12c of FIG. 12a. FIG. 12d is a cut-away perspective view of universal socket 170 taken along a cut-line 12d-12d of FIG. 12a.

In this embodiment, universal socket 170 includes a universal socket body 171 having a conduit fitting body 171a and socket fitting body 171b. An unsocketed body opening 172a extends through conduit fitting body 171a, and an unsocketed body channel 173 extends through conduit fitting body 171a and between unsocketed body opening 172a and a stop piece 174. Unsocketed body opening 172a is sized and shaped to receive distal conduit end 110b of conduit 110. Body channel 173a is unsocketed because it does not include a facet.

Unsocketed body opening 172b extends through socket fitting body 171b, and an unsocketed body channel 173b extends through socket fitting body 171b and between unsocketed body opening 172b and stop piece 174. Body channel 173b is unsocketed because it does not include a facet.

Socket piece 140 includes opposed proximal fastener opening 175a and 175b, which extend through conduit fitting body 171a. Fastener openings 175a and 175b are positioned opposed to each other, as shown in FIG. 12c, so that an object, such as a fastener, can be extended through them. Further, fastener openings 175a and 175b are positioned so that conduit fastener openings 118a and 118b are aligned with fastener openings 175a and 175b, respectively, when distal conduit end 110b of conduit 110 is extended through unsocketed body opening 172a. In this way, a fastener (not shown) can be extended through unsocketed body opening 172a and conduit fastener openings 118a and 118b so that socket piece 140 and distal conduit end 110b of conduit 110 are coupled together.

Socket piece 140 includes opposed distal fastener openings 176a and 176b, which extend through socket fitting body 171b. Fastener openings 176a and 176b are positioned opposed to each other, as shown in FIG. 12d, so that an object, such as a fastener, can be extended through them.

Unsocketed body opening 172b is sized and shaped to receive an object, such as a socketed chuck. Corresponding fasteners are extended through distal fastener openings 176a and 176b to hold the object in unsocketed body channel 173b, as will be discussed in more detail presently.

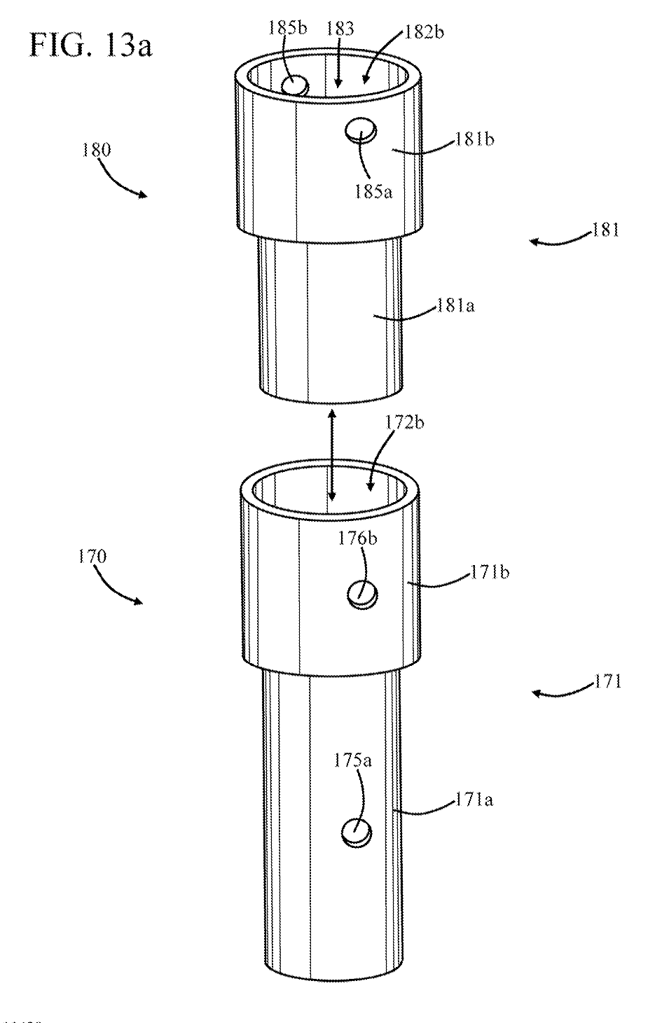

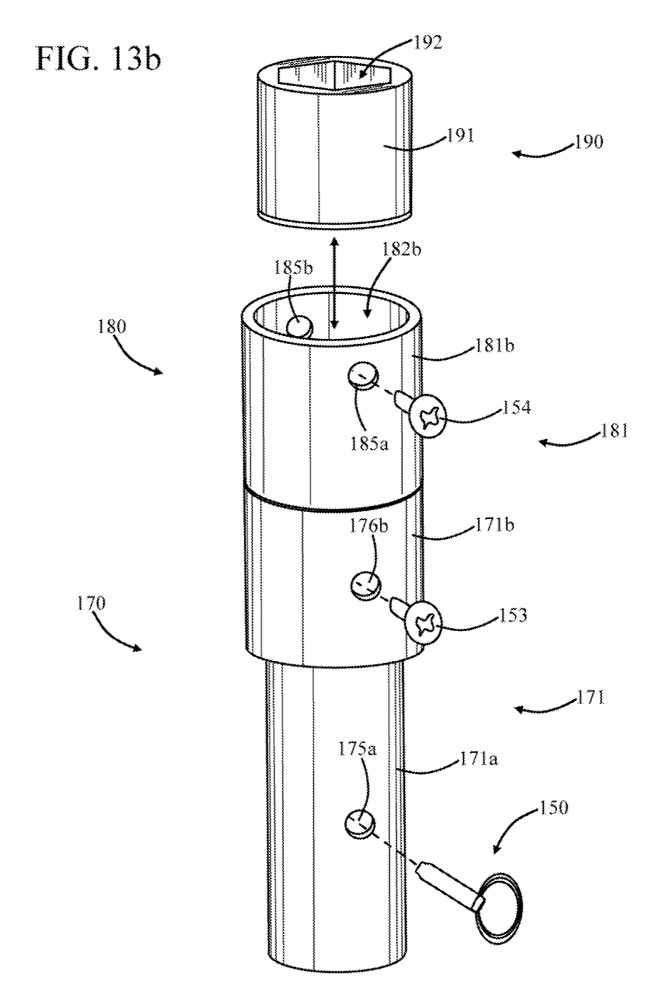

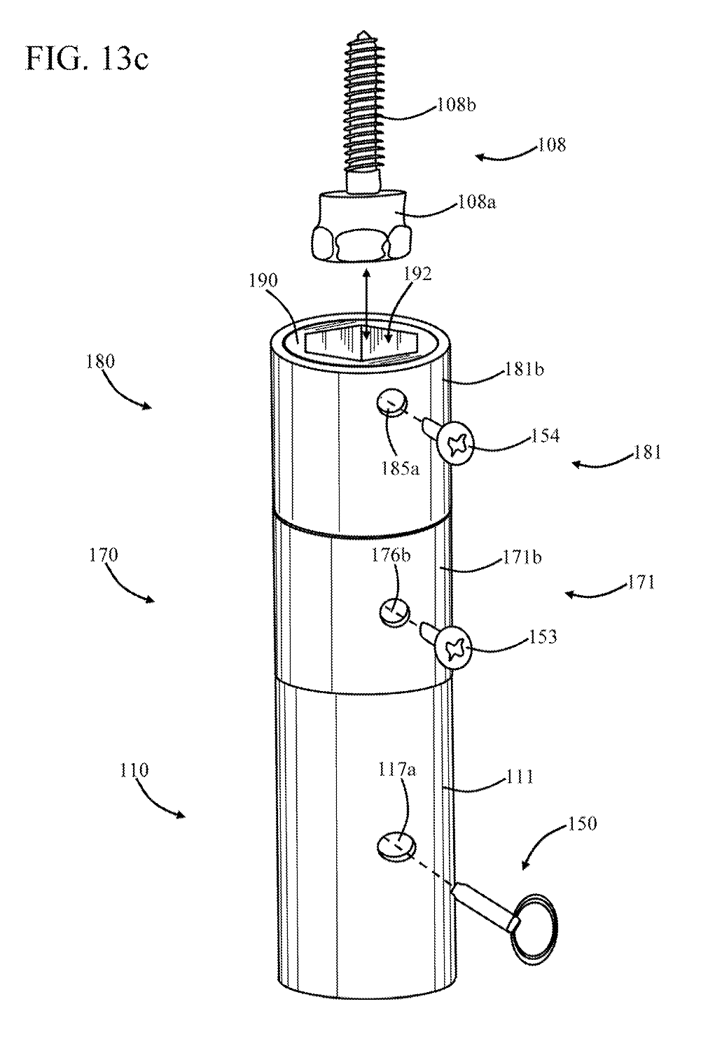

FIG. 13a is a perspective view of a socketed chuck 180, which can be coupled to universal socket 170 of FIG. 12a. In this embodiment, socketed chuck 180 includes a socketed chuck body 181 having a socket chuck fitting 181a and socket chuck holder 181b. An unsocketed chuck opening 182b extends through socket chuck holder 181b, and an unsocketed body channel 183 extends through socket chuck holder 181b. Body channel 183 is unsocketed because it does not include a facet. Socket piece 140 includes opposed proximal fastener openings 185a and 185b, which extend through socket chuck holder 181b. Fastener openings 185a and 185b are positioned opposed to each other. Unsocketed chuck opening 182b is sized and shaped to receive an object, such as a socketed plug. Corresponding fasteners are extended through distal fastener openings 185a and 185b to hold the object in unsocketed body channel 183, as will be discussed in more detail presently.

FIG. 13b is a perspective view of a socketed plug 190, which can be coupled to socketed chuck 180 of FIG. 13a. In this embodiment, socketed plug 190 includes a socket plug body 191, and a socketed plug opening 192 extending through socket plug body 191. Socket plug body 191 is sized and shaped to be received by unsocketed chuck opening 182b and unsocketed body channel 183. Plug opening 192 is socketed because it includes at least one facet. A fastener, such as fastener 154, is extended through distal fastener openings 185a and 185b to hold socketed plug 190 in unsocketed body channel 183. In this way, socketed plug 190 is coupled to socketed chuck.

FIG. 13c is a perspective view of fastener 108 of FIG. 2a, which can be coupled to socketed plug 190 of FIG. 13b. In this embodiment, head 108a is moved through socketed plug opening 192. Head 108a is faceted so that it matches the facets of plug opening 192, and fastener 108 will rotate in response to the rotation of socketed plug 190. Conduit 110 is coupled to universal socket 170 by extending conduit fitting body 171a through conduit body channel 113 proximate to distal conduit end 110b. Pin 150 is then used to couple conduit 110 to universal socket 170 by extending pin shank 152 through conduit fastener openings 118a and 118b, as well as through proximal fastener openings 175a and 175b. It should be noted that socketed plug 190 rotates in response to the rotation of conduit 110. Conduit 110 can be rotated in many different ways, such as by using, drill 101.

The embodiments of the invention described herein are exemplary and numerous modifications, variations and rearrangements can be readily envisioned to achieve substantially equivalent results, all of which are intended to be embraced within the spirit and scope of the invention as defined in the appended claims.

1. A pole assembly, comprising:
a chuck, which includes a chuck body with opposed fastener openings extending therethrough, and a shank;
a socket piece, which includes a conduit fitting body and a socket piece body, and opposed fastener openings extending through the conduit fitting body, and a socketed body opening extending through the socket fitting body;
a conduit which extends through a distal chuck body opening of the chuck and an unsocketed body opening of the conduit fitting body.

2. The pole assembly of claim 1, further including a first pin which couples the conduit to the chuck.

3. The pole assembly of claim 2, further including a second pin which couples the conduit to the socket piece.

4. The pole assembly of claim 1, wherein the socketed body opening includes a plurality of facets.

5. The pole assembly of claim 1, wherein the socket piece includes a socket stop piece which extends between the conduit fitting body and socket fitting body.

6. The pole assembly of claim 1, further including a fastener which extends through the socketed body opening.

7. The pole assembly of claim 1, wherein the conduit includes electrical conduit.

8. A pole assembly, comprising:
a chuck, which includes a chuck body with opposed fastener openings extending therethrough, and a shank;
a coupler, which includes a proximal fitting body and distal fitting body, and proximal fastener openings extends through the proximal fitting body and distal fastener openings which extend through the distal fitting body;
a first conduit which extends through a distal chuck body opening of the chuck and a proximal coupler opening of the coupler;
a socket piece, which includes a conduit fitting body and a socket piece body, and opposed fastener openings extending through the conduit fitting body, and a socketed body opening extending through the socket fitting body; and
a second conduit which extends through a distal coupler opening of the coupler and an unsocketed body opening of the conduit fitting body.

9. The pole assembly of claim 8, further including a first pin which couples the first conduit to the chuck, and a second pin which couples the first conduit to the coupler.

10. The pole assembly of claim 9, further including a third pin which couples the second conduit to the coupler, and a fourth pin which couples the second conduit to the socket piece.

11. The pole assembly of claim 8, wherein the socketed body opening includes a plurality of facets.

12. The pole assembly of claim 8, wherein the socket piece includes a socket stop piece which extends between the conduit fitting body and socket fitting body.

13. The pole assembly of claim 8, further including a fastener which extends through the socketed body opening.

14. The pole assembly of claim 8, wherein the first and second conduits include electrical conduit.
